(19) United States
(12) Patent Application Publication
(10) Pub. No.: US 2015/0171928 A1
(43) Pub. Date: Jun. 18, 2015

(54) USB MEMORY DEVICE CONNECTED WITH SMART PHONE

(71) Applicant: TRATEC INFORMATION & COMMUNICATION CO., LTD, Seongnam-si (KR)

(72) Inventor: Su Jung Lee, Seoul (KR)

(21) Appl. No.: 14/411,910

(22) PCT Filed: Jul. 23, 2013
(86) PCT No.: PCT/KR2013/006554

§ 371 Date: Dec. 29, 2014

(30) Foreign Application Priority Data
Aug. 2, 2012 (KR) 10-2012-0084936
Apr. 23, 2013 (KR) 10-2013-0044690

(51) Int. Cl. H04B 5/00; H04M 1/725; H04W 4/22

(52) U.S. Cl. CPC H04B 5/0031; H04W 4/22; H04M 1/7253

(57) ABSTRACT

A USB memory device comprises a USB Bluetooth module for communication with a smart phone, a USB connector for connecting to an external terminal, a memory for storing data transmitted from the external terminal through the USB connector, a battery for supplying power to the USB Bluetooth module, a connection button for executing an application of the smart phone, a buzzer driven by the control of the USB Bluetooth module, and an LED driven by the control of the USB Bluetooth module, wherein the USB Bluetooth module automatically connects by the smart phone Bluetooth module and drives the buzzer and the LED and turns a switching element “off” to cut off power between the USB connector and the memory if no wireless signal is received from the smart phone, and the smart phone outputs an alarm sound if no wireless signal is received from the USB Bluetooth module.

### TECHNICAL FIELD

The present invention relates to a USB memory device interworking with a smart phone, and more specifically, to a USB memory device interworking with a smart phone, which enables a USB memory to always interwork with the smart phone that is always carried and that has data recorded therein, thus preventing the USB memory and the smart phone from being lost, and even if lost, preventing the same from being used by others.

The present invention also relates to a USB memory device interworking with a smart phone, which may alert a guardian or an emergency rescue organization to an emergency by simple button manipulation.

The present invention also relates to a USB memory device interworking with a smart phone, wherein the smart phone and the USB memory device embed their respective Bluetooth modules that may be adapted to interwork with each other, so that when the smart phone is positioned apart from the USB memory device by a predetermined distance, the smart phone and the USB memory device may output an alert signal to inform the user that he left the smart phone or USB memory device behind, thus preventing the smart phone or the USB memory device from being lost.

The present invention also relates to a USB memory device interworking with a smart phone, wherein when the USB memory device departs from a distance within which the USB memory device may interwork with the smart phone, the USB memory device stops power supplying power to the memory of the USB memory device so as to prevent others from using the USB memory device when the USB memory device is lost.

The present invention also relates to a USB memory device interworking with a smart phone, wherein when an emergency, such as robbery or kidnapping, occurs, a message may be transmitted to a guardian or emergency rescue organization by manipulating a button of the USB memory device, and the current location of the smart phone may be obtained through the GPS or a network, and the current location may be transmitted to the guardian or emergency rescue organization.

### DISCUSSION OF RELATED ART

An increased volume of electronic files led to a reduction in use of floppy discs that have less portability and storage capacity, and easy-to-use portable storage devices are taking up the share of the conventional storage units. Among others, USB memories are gaining popularity thanks to increased data storage capacity alongside reduced costs.

The spread of portable storage devices prompts the spread of security schemes for preventing others from malicious access to the data retained in the devices. However, use of such portable storage devices comes with some problems. An analysis of the cause of a leak of personal information shows that it, in many cases, comes from the theft or loss of USB memories or other portable storage devices or laptop computers rather than computer viruses or worms.

In other words, the personal information leakage may be primarily attributed to the theft or loss of portable storage devices. Accordingly, a need exists for a security technique that may safely protect data when the portable storage device retaining the data is lost or stolen.

Korean Patent Application Publication Nos. 10-2007-0121265, 10-2007-0121264, and 10-2012-0044678 and Korean Patent No. 10-0940508 disclose security and methods for preventing a portable storage device, i.e., a USB memory, from being stolen.

Specifically, Korean Patent Application Publication No. 10-2007-0121265 discloses a ‘system for preventing a USB memory from being lost and stolen,’ including a main unit having a first nearfield radio communication module, a USB connector connected or disconnected to/from the main unit, a theft preventing module forming a communication channel with the first nearfield radio communication module and sending out an alert when a predetermined condition is met, a memory module connected with the main unit to function as a high-volume storage unit, and a USB hub distributing signals communicated through the USB connector to the theft preventing module and the memory module, wherein the loss or theft of the USB memory is informed depending on the state of a link included in the communication channel, the distance between the main unit and the USB memory, and the intensity of signals.

Korean Patent Application Publication No. 10-2007-0121264 discloses a ‘system and method for preventing a USB memory from being stolen,’ including a USB connector connected to a USB port of a main computer, a memory region performing an operation of reading and writing data, and a USB controller controlling access from the main computer to the memory region, wherein the memory region is mounted and activated in the main computer, and an alert application providing an alert to the main computer when the USB connector is disconnected from the USB port without performing a USB device removal process, wherein an alert goes off when the USB memory connected with the main computer is separated from the computer without a proper procedure.

Korean Patent No. 10-0940508 discloses a ‘security USB memory managing system,’ including a server system that embeds a program for managing (use of) data retained in a USB memory and communicates information with the program for managing the use constraint and history of the USB memory, thereby enabling management of a USB memory used in a PC over a network.

Korean Patent Application Publication No. 10-2012-0044678 discloses a ‘USB security device and security method thereof,’ wherein the USB security device embeds an encryption module using a smart card to encrypt and store data and decrypt and output the data, thereby protecting data from the loss of the USB security device or hacking while preventing others from driving the USB security device.

However, the above-listed security and theft preventing methods are adopted in a PC or network system that cannot be carried and thus may be difficult to apply to small portable storage units such as USB memory drives.

Conventional positioning and emergency alerting applications for smart phones may pinpoint a position using the GPS and a network and send a message to a predetermined site. However, the need for opening and unlocking the smart phone and executing the application renders it difficult to respond to an emergency. A smart phone may be equipped with a function of alerting the public to an emergency by shaking the smart phone or manipulating a specific external button. In this case, however, it is not easy to operate the external button if the smart phone is put in the back or is positioned far away. There are a diversity of software programs or terminals that may warn of an emergency, but none of them can pinpoint the exact location on the site, thus failing to achieve the successful rescue. The pinpointing using the GPS or networks has low accuracy in downtown. In particular, such pinpointing is limited when the person to be rescued is positioned in a building.

### SUMMARY

Accordingly, the present invention has been made to address the above-described issues of the prior art, and an object of the present invention is to prevent the loss of a USB memory and a smart phone always carried and having data recorded therein, and even if lost, prevent the same from being used by others.

Further, the present invention aims to alert a guardian or an emergency rescue organization to an emergency by simple button manipulation.

Further, the present invention aims to prevent the loss of a USB memory device or a smart phone by alerting the user when he left the USB memory device or smart phone behind.

Further, the present invention aims to, when an emergency, such as robbery or kidnapping, occurs, transmit a message to a guardian or emergency rescue organization by manipulating a button of the USB memory device, and the current location of the smart phone may be obtained through the GPS or a network, and the current location may be transmitted to the guardian or emergency rescue organization.

To achieve the above objects, according to a first embodiment of the present invention, a USB memory device interworking with a smart phone comprises: a USB Bluetooth module for near-field communication with a smart phone Bluetooth module of a smart phone; a USB connector for connection with an external terminal; a memory storing various data transmitted from the external terminal through the USB connector; a battery supplying power to the USB Bluetooth module; a buzzer driven under the control of the USB Bluetooth module; and an LED driven under the control of the USB Bluetooth module, wherein the USB Bluetooth module is configured to automatically interwork by the smart phone Bluetooth module, wherein the USB Bluetooth module drives the buzzer and the LED when no radio signal is received from the smart phone, and the smart phone outputs an alert sound wherein when no radio signal is received from the USB Bluetooth module.

According to a second embodiment of the present invention, a USB memory device interworking with a smart phone comprises: a USB Bluetooth module for near-field communication with a smart phone Bluetooth module of a smart phone; a USB connector for connection with an external terminal; a memory storing various data transmitted from the external terminal through the USB connector; a battery supplying power to the USB Bluetooth module; and an emergency button connected with the USB Bluetooth module, wherein the USB Bluetooth module is configured to automatically interwork by the smart phone Bluetooth module, wherein the USB Bluetooth module transmits an emergency radio signal when the emergency button is manipulated, and wherein the smart phone, when receiving the emergency radio signal from the USB Bluetooth module, accesses a pre-registered guardian or an emergency rescue organization to transmit a message reporting an emergency.

In the second embodiment, the smart phone detects location information of the smart phone, which is computed through a GPS and a network, and an MAC address of a nearby Wi-Fi or Bluetooth device and a signal strength, which are searched in an ambient radio environment and transmits the same to the guardian or the emergency rescue organization.

In the second embodiment, the smart phone detects location information of the smart phone, which is computed through a GPS and a network, an MAC address of a Wi-Fi or Bluetooth module of the smart phone, an address of a Bluetooth module of the USB memory device, and a signal strength and transmits the same to the guardian or the emergency rescue organization, and the Wi-Fi module of the smart phone enters into AP mode (Wi-Fi hotspot mode) so that the location of the smart phone may be identified.

According to a third embodiment of the present invention, a USB memory device interworking with a smart phone comprises: a USB Bluetooth module for near-field communication with a smart phone Bluetooth module of a smart phone; a USB connector for connection with an external terminal; a memory bi-laterally communicating various data with the external terminal through the USB connector and storing the various data transmitted from the external terminal; a battery supplying power to the USB Bluetooth module; and a switching device switching on/off power supplied from the USB connector to the memory, wherein when no radio signal for interworking is received from the smart phone, the USB Bluetooth module turns off the switching device to prevent the external terminal from recognizing the memory.

In the third embodiment, wherein only when a separate password is entered, the smart phone 2 outputs a radio signal for interworking.

According to a fourth embodiment of the present invention, a USB memory device interworking with a smart phone comprises: a USB Bluetooth module for near-field communication with a smart phone Bluetooth module of a smart phone; a USB connector for connection with an external terminal; a memory storing various data transmitted from the external terminal through the USB connector; a battery supplying power to the USB Bluetooth module; and an interworking button for executing a specific application of the smart phone, wherein when the interworking button is manipulated, the USB Bluetooth module transmits an interworking button radio signal, and when receiving the interworking button radio signal from the USB Bluetooth module, the smart phone executes a pre-registered application.

According to the first to fourth embodiments, when the USB connector 11 is connected with the external terminal, the battery 12 is charged with power supplied from the external terminal.

According to the present invention, a USB memory device may always interwork with a smart phone, which is carried and has data recorded therein, thus preventing the loss of the USB memory device and the smart phone, and even when lost, cutting off use by others.

Further, according to the present invention, a button may be included in a small-size USB memory device that is carried in pocket or in the form of a necklace. When an emergency occurs, an emergency alerting application of the smart phone may be remotely executed by simply manipulating the button to alert a guardian or emergency rescue organization to the emergency regardless of where the smart phone is positioned, thus allowing for a swift response to the emergency.

Further, according to the present invention, the smart phone and the USB memory device embed their respective Bluetooth modules that may be adapted to interwork with each other, so that when the smart phone is positioned apart from the USB memory device by a predetermined distance, the smart phone and the USB memory device may output an alert signal to inform the user that he left the smart phone or USB memory device behind, thus preventing the smart phone or the USB memory device from being lost.

Further, according to the present invention, when an emergency, such as robbery or kidnapping, occurs, a message may be transmitted to a guardian or emergency rescue organization by manipulating a button of the USB memory device, and the current location of the smart phone may be obtained through the GPS or a network, and the current location may be transmitted to the guardian or emergency rescue organization, thus allowing for an easy rescue of the user that is put in trouble.

### BRIEF DESCRIPTION OF DRAWINGS

FIG. 1 is a block diagram schematically illustrating a USB memory device interworking with a smart phone according to the present invention.

FIG. 2 is a flowchart illustrating a process of registering a USB memory device 1 for allowing the USB memory device to interwork with a smart phone 2.

FIG. 3a and FIG. 3b are flowcharts illustrating processes of reporting loss between a USB memory device 1 and a smart phone 2.

FIG. 4 is a flowchart illustrating a process performed when an emergency occurs.

FIG. 5 is a flowchart illustrating a process of maintaining security of a USB memory device 1.

<BRIEF DESCRIPTION OF ELEMENTS>

| | |
|---|---|
| 1: USB memory device | 2: smart phone |
| 11: USB connector | 12: battery |
| 13: USB Bluetooth module | 14: memory |
| 15: buzzer | 16: LED |
| 17: interworking button | 18: emergency button |
| 21: smart phone Bluetooth module | |

### DETAILED DESCRIPTION OF EMBODIMENTS

The present invention is to enable a USB memory device and a smart phone, which is carried and has data recorded therein, to always interwork with each other to thus prevent loss of the USB memory device and the smart phone, and even when lost, to cut off use by others.

Hereinafter, preferred embodiments of the present invention are described in detail with reference to the accompanying drawings.

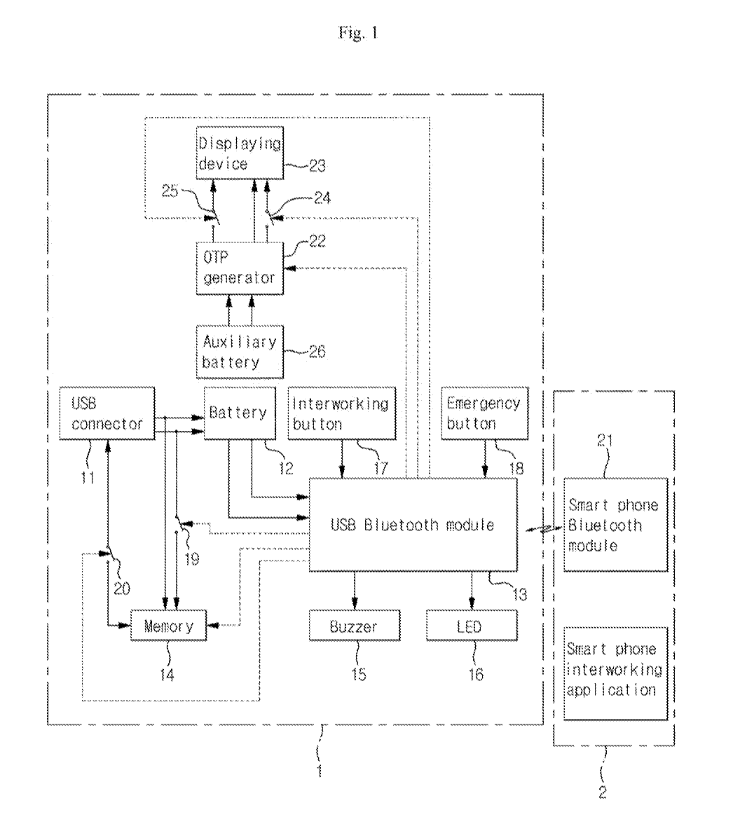

FIG. 1 is a block diagram schematically illustrating a USB memory interworking with a smart phone according to the present invention.

Referring to FIG. 1, the USB memory device interworking with the smart phone includes the USB memory device 1 and the smart phone 2. The USB memory device 1 includes a USB connector 11, a battery 12, a USB Bluetooth module 13, a memory 14, a buzzer 15, an LED 16, an interworking button 17, an emergency button 18, switching devices 19, 20, 24, and 25, an OTP (One Time Password) generator 22, a displaying device 23, and an auxiliary batter), 26, and the smart phone 2 includes a smart phone Bluetooth module 21 and various applications such as a smart phone interworking application.

Here, the USB Bluetooth module 13 is provided for performing nearfield communication with the smart phone Bluetooth module 21 of the smart phone 2, and although not specifically shown in the drawings, the USB Bluetooth module 13 provides a function of controlling the overall operation such as allowing the USB memory device 1 to interwork with the smart phone 2 and operations for loss, emergency, or security.

The USB connector 11 is a port for connection with an external terminal such as a personal computer or laptop computer like that of a typical USB memory device. The USB connector 11 transmits data from an external terminal to the memory 14, and the USB connector 11 supplies power from the external terminal to the battery 12 and the memory 14. Of course, the circuit may also be configured to supply power to the memory 14 from the USB connector 11 but not from the battery 12, so that while remaining disconnected from the external terminal, the memory 14 usually does not consume power.

The memory 14 stores various data transmitted from the external terminal, and the memory 14 stores data transmitted from the external terminal only when power is supplied from the external terminal. Of course, data stored in the memory 14 may be read out through the external terminal.

In other words, the memory 14 and the external terminal may bi-laterally communicate various data through the USB connector 11.

The interworking button 17 is a button for executing a particular interworking application registered in the smart phone 2. An application frequently used may be registered to be easily executed by one touch of button manipulation. A critical security-related application may be executed only by manipulating the interworking button 17, thus reinforcing the security of program.

The buzzer 15 and the LED 16 are driven by controlling the USB Bluetooth module 13, and the buzzer 15 and the LED 16 output an alert signal when the user leaves the smart phone 2 behind or when the smart phone 2 is stolen or lost.

Further, when the user leaves the USB memory device 1 behind or the USB memory device 1 is lost or stolen, the smart phone 2 may output an alert sound so that the user may recognize that the USB memory device 1 has been stolen or lost.

The emergency button 18 is a button included in the USB memory device 1 to alert someone to an emergency such as abduction and to request a rescue.

Upon manipulation of the emergency button 18, the USB Bluetooth module 13 transmits an emergency radio signal to report an emergency, and when receiving the emergency radio signal from the USB Bluetooth module 13, the smart phone 2 accesses a pre-registered guardian or emergency rescue organization and transmits a message reporting the emergency to the guardian or organization.

Of course, for such purpose, the message to be transmitted, along with the telephone numbers of the guardian and the organization, should be previously registered in the smart phone 2.

Further, when the emergency button 18 is manipulated, the smart phone 2, for exact positioning, detects its location information, which is computed through the GPS and a network, and a signal strength and the MAC address of a nearby Wi-Fi or Bluetooth device searched in an ambient radio environment and periodically transmits the same to the guardian or emergency rescue organization.

Still further, when the emergency button 18 is manipulated, the smart phone 2, for exact positioning, may detect its location information, which is computed through the GPS and a network, the MAC address of the Wi-Fi or Bluetooth module of the smart phone 2, an address of the Bluetooth module of the USB memory device, and a signal strength and periodically transmit the same to the guardian or emergency rescue organization, and the Wi-Fi module of the smart phone may enter into AP mode (Wi-Fi hotspot mode).

A switching device 19 is positioned between the USB connector 11 and the memory 14, and the switching device 19 turns on/off under the control of the USB Bluetooth module 13 to switch on/off the power supplied from the USB connector 11 to the memory 14.

Here, the USB Bluetooth module 13 turns off the switching device 19 to prevent the memory 14 from operating when no radio signal for interworking is received from the smart phone 2.

In other words, the USB Bluetooth module 13 turns off the switching device 19 to cut off the power supplied to the memory 14 so that the external terminal connected with the USB connector 11 cannot recognize the memory 14.

In this case, the battery 12 intensively receives power from the external terminal connected with the USB connector 11.

Further, a switching device 20 is provided to switch on/off various data bi-laterally communicated between the memory 14 and the external terminal through the USB connector 11.

Here, when no radio signal for interworking is received from the smart phone 2, the USB Bluetooth module 13 turns off the switching device 20 to prevent the external terminal from recognizing the memory 14.

In other words, various data stored in the memory 14 may be prevented from being transmitted to the external terminal connected with the USB connector 11.

Further, when the switching device 19 for power on/off does not operate, the USB Bluetooth module 13 immediately turns off the switching device 20 for switching on/off transmission of various data to stop transmission of various data with the external terminal, and in an opposite case thereof, the USB Bluetooth module 13 may immediately turn off the switching device 19 for power on/off.

In other words, it prevents the external terminal from recognizing the memory 14.

Further, the USB Bluetooth module 13 may simultaneously turn off the switching device 19 for power on/off and the switching device 20 for switching on/off transmission of various data to ensure that the external terminal cannot recognize the memory 14.

The USB Bluetooth module 13, when no radio signal for interworking is received from the smart phone 2, sends an operation stop signal to the memory 14 so that the memory 14 stops operating.

In other words, the USB Bluetooth module 13 may send the operation stop signal to the memory 14 to forcedly stop the operation of the memory 14, so that the external terminal cannot recognize the memory 14.

As a result, access of the memory 14 to the external terminal is cut off until interworking is achieved between the USB Bluetooth module 13 and the smart phone 2.

In other words, the USB memory device 1 may read out the data stored therein only when the interworking with the smart phone 2 is maintained, thus preventing others from accessing the data stored in the USB memory device 1.

Meanwhile, there are also provided the OTP generator 22 for generating a password used for electronic financial transactions, the displaying device 23 for outputting the password generated by the OTP generator 22 on the screen, the auxiliary battery 26 for supplying power to the OTP generator 22, and the switching device 24 for switching on/off the power supplied from the auxiliary battery 26 through the OTP generator 22 to the displaying device 23.

In this case, the battery 12 receiving power from the USB connector 11 and the auxiliary battery 26 are independently configured from each other.

Here, the USB Bluetooth module 13, when no radio signal for interworking is received from the smart phone 2, turns off the switching device 24 to stop the displaying device 23 from operating.

In other words, the USB Bluetooth module 13 turns off the switching device 24 to cut off the power supplied to the displaying device 23 to prevent the password generated by the OTP generator 22 from being displayed on the screen.

Further, there is provided the switching device 25 for switching on/off transmission of the password generated by the OTP generator 22 to the displaying device 23.

Here, the USB Bluetooth module 13, when no radio signal for interworking is received from the smart phone 2, turns off the switching device 25 to stop the password from being transmitted to the displaying device 23.

Further, when the switching device 24 for switching on/off the power supplied to the displaying device 23 does not operate, the USB Bluetooth module 13 immediately turns off the switching device 25 for switching on/off transmission of the password to the displaying device 23 to cut off transmission of the password generated by the OTP generator 22 to the displaying device 23, and in an opposite case thereof, the USB Bluetooth module 13 may immediately turn off the switching device 24 for switching on/off the power supplied to the displaying device 23.

Further, the USB Bluetooth module 13 may simultaneously turn off the switching device 24 for switching on/off the power supplied to the displaying device 23 and the switching device 25 for switching on/off transmission of the password to the displaying device 23, thus reinforcing security of the password.

The USB Bluetooth module 13, when no radio signal for interworking is received from the smart phone 2, sends a password generation stop signal to the OTP generator 22 so that no password is generated from the OTP generator 22.

In other words, the USB Bluetooth module 13 sends the password generation stop signal to the OTP generator 22 to forcedly stop the OTP generator 22 from generating a password while simultaneously stopping the password from being displayed on the screen and from being transmitted to the displaying device 23.

Resultantly, as long as the interworking between the USB Bluetooth module 13 and the smart phone 2 is not achieved, passwords generated from the OTP generator 22 at every constant times cannot be identified through the displaying device 23.

In particular, the security of the USB memory device 1 may be increased by allowing a radio signal transmitted from the smart phone 2 for interworking between the USB memory device 1 and the smart phone 2 to be output only when a password separately set up is entered.

The battery 12 may be recharged with the power supplied from the external terminal when the USB connector 11 is connected with the external terminal, thus securing power for driving the USB memory device 1.

Here, when no power is supplied from the battery 12 of the USB memory device 1, the switching device 19 preferably keeps turned-off for increased security, thus preventing others from reading out the data retained in the USB memory device 1.

The smart phone 2 embeds an application for reporting the loss or theft of the USB memory device 1, an application for reporting a dangerous situation and providing information for positioning, and an application for security of the USB memory device 1. Of course, the smart phone 2 should have information regarding the USB memory device 1 previously registered therein for interworking.

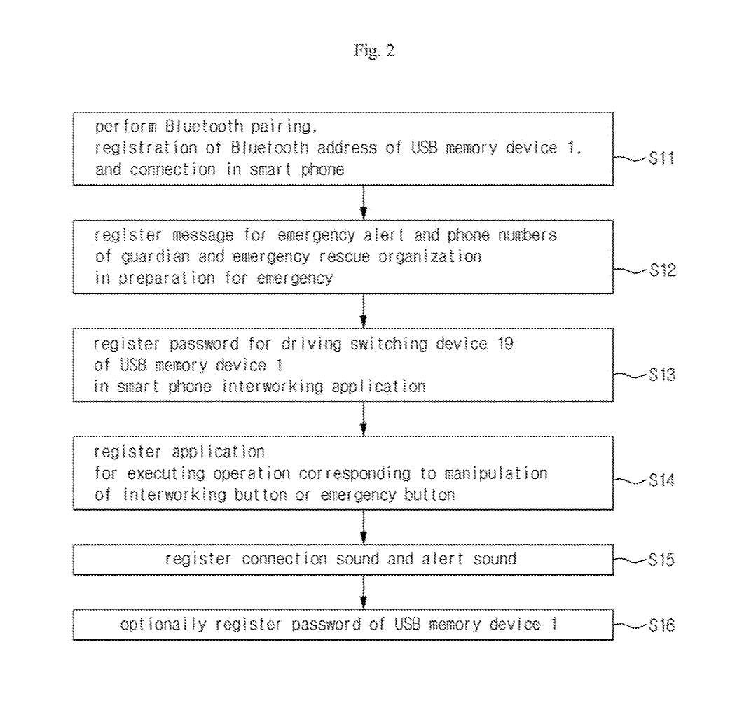

FIG. 2 is a flowchart illustrating a process of registering a USB memory device 1 for interworking between the USB memory and a smart phone 2.

First, a user registers Bluetooth pairing and the Bluetooth address of the USB memory device 1 in the smart phone 2 and makes a connection (S11).

Subsequently, the user previously registers a message for reporting an emergency together with the phone number of a guardian or emergency rescue organization for reporting an emergency in the smart phone 2. Further, the user registers a password for activating the switching device 19 of the USB memory device 1 in the smart phone 2.

The user registers an alert sound or connection sound or an application for executing an operation corresponding to manipulation of the interworking button or emergency button in the smart phone 2, and the user previously registers, e.g., whether to use a password for increasing security of the USB memory device 1 (S14, S15, and S16).

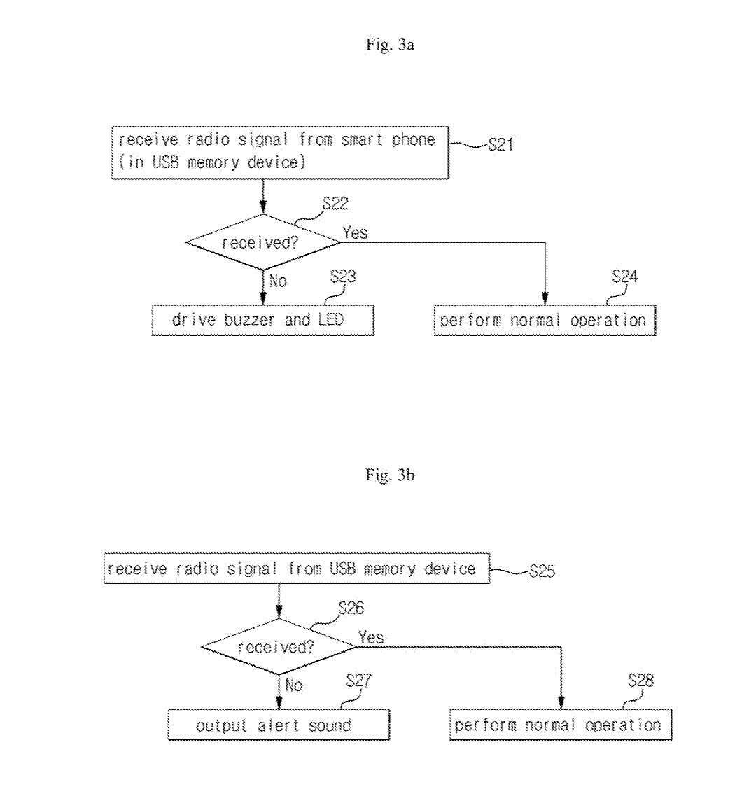

FIG. 3a and FIG. 3b are flowcharts illustrating processes of reporting loss between a USB memory 1 and a smart phone 2.

First, in the case of the USB memory device 1, the USB memory device 1 receives a radio signal from the smart phone 2 (S21) as shown in FIG. 3a to identify whether the previously registered radio signal is normally received (S12).

In case a result shows the radio signal is not received, the USB memory device 1 determines that the smart phone 2 is positioned away from the USB memory device 1 by a predetermined distance or more, and the USB memory device 1 drives the buzzer and the LED to report the same (S23). In case the radio signal is normally received, the USB memory device 1 determines that the user carries both the USB memory device 1 and the smart phone 2 and the USB memory device 1 performs a normal operation (S24).

In the case of the smart phone 2, the smart phone 2 receives a radio signal from the USB memory device 1 (S25) as shown in FIG. 3b to identify whether the previously registered radio signal is normally received (S26).

In case a result shows the radio signal is not received, the smart phone 2 determines that the USB memory device 1 is positioned away from the smart phone 2 by a predetermined distance or more, and the smart phone 2 outputs an alert sound to report the same (S27). In case the radio signal is normally received, the smart phone 2 determines that the user carries both the USB memory device 1 and the smart phone 2, and the smart phone 2 performs a normal operation (S28).

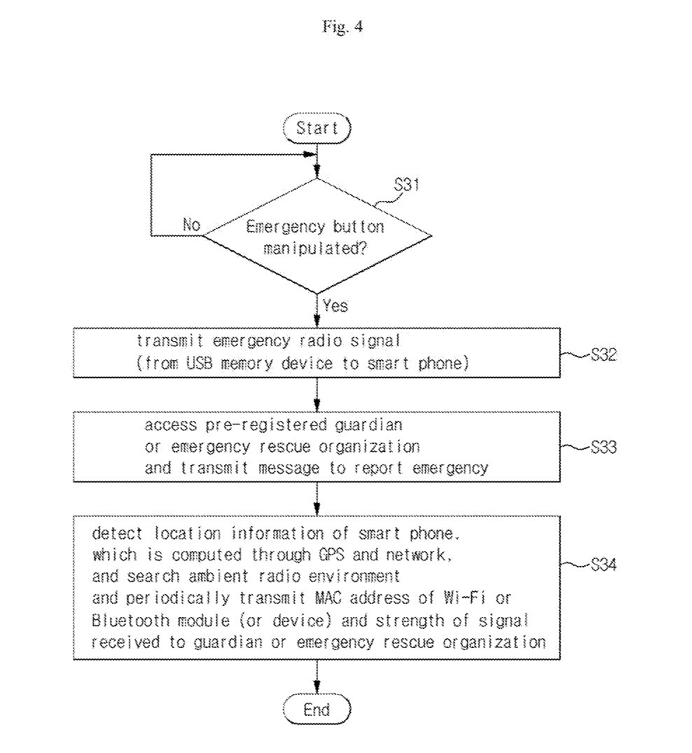

FIG. 4 is a flowchart illustrating a process performed when an emergency occurs.

First, when the user carrying the USB memory device 1 presses the emergency button 18 for two or three seconds to report an emergency (S31), the USB memory device 1 transmits, to the smart phone 2, an emergency radio signal for reporting the emergency (S32).

Of course, in case the emergency button 18 is pressed for a short time, an indication sound registered in the smart phone 2 may be output to draw attention for help.

When receiving a radio signal for reporting an emergency from the USB memory device 1, the smart phone 2 sends a text message to the previously registered guardian or emergency rescue organization or to access a server to report the emergency (S33).

The smart phone 2 detects its location information, which is computed through the GPS and a network, and a signal strength and the MAC address of a nearby Wi-Fi or Bluetooth device searched in an ambient radio environment and periodically transmits the same to the guardian or emergency rescue organization (S34).

Further, the smart phone 2 may detect its location information computed through the GPS and a network, the MAC address of the Wi-Fi or Bluetooth module of the smart phone 2, an address of the Bluetooth module of the USB memory device, and a signal strength and transmit the same to the guardian and the emergency rescue organization, and the Wi-Fi module of the smart phone may enter into AP mode (Wi-Fi hotspot mode), so that a person from the emergency rescue organization may perform accurate positioning in the site based on the received MAC address of the Wi-Fi or Bluetooth module, Bluetooth address of the USB memory device 1 and signal strength to track the location of the user.

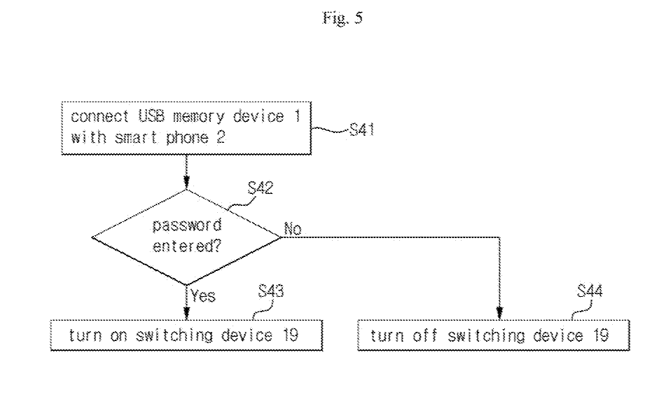

FIG. 5 is a flowchart illustrating a process of maintaining security of a USB memory device 1.

First, an operation for maintaining security of the USB memory device 1 is performed while the USB memory device 1 is interoperably connected with the smart phone 2 (S41). In other words, it is impossible to record data in the USB memory device 1 or to read out recorded data unless the USB memory device 1 interworks with the smart phone 2.

While the USB memory device 1 interworks with the smart phone 2, the USB memory device 1 determines whether a password for security is contained in a radio signal received from the smart phone 2, i.e., whether the user has entered the password for security in the smart phone 2.

In case a result shows that the password has been entered, the USB memory device 1 switches the switching device 19 on to supply power from the USB connector 11 to the memory 14, so that the user may store data in the USB memory device 1 or read and utilize the data stored in the USB memory device 1.

In contrast, unless the password has been entered, the USB memory device 1 switches the switching device 19 off to cut off power supplied from the USB connector 11 to the memory 14, thus preventing others from storing data in the USB memory device 1 or reading out the data stored in the USB memory device 1.

1. A USB memory device interworking with a smart phone, the USB memory device comprising:
a USB Bluetooth module for near-field communication with a smart phone Bluetooth module of a smart phone;
a USB connector for connection with an external terminal;
a memory storing various data transmitted from the external terminal through the USB connector;
a battery supplying power to the USB Bluetooth module;
a buzzer driven under the control of the USB Bluetooth module; and
an LED driven under the control of the USB Bluetooth module, wherein the USB Bluetooth module is configured to automatically interwork by the smart phone Bluetooth module, wherein the USB Bluetooth module drives the buzzer and the LED when no radio signal is received from the smart phone, and the smart phone outputs an alert sound wherein when no radio signal is received from the USB Bluetooth module.

2. A USB memory device interworking with a smart phone, the USB memory device comprising:
a USB Bluetooth module for near-field communication with a smart phone Bluetooth module of a smart phone;
a USB connector for connection with an external terminal;
a memory storing various data transmitted from the external terminal through the USB connector;
a battery supplying power to the USB Bluetooth module; and
an emergency button connected with the USB Bluetooth module, wherein the USB Bluetooth module is configured to automatically interwork by the smart phone Bluetooth module, wherein the USB Bluetooth module transmits an emergency radio signal when the emergency button is manipulated, and wherein the smart phone, when receiving the emergency radio signal from the USB Bluetooth module, accesses a pre-registered guardian or an emergency rescue organization to transmit a message reporting an emergency.

3. The USB memory device of claim 2, wherein the smart phone detects location information of the smart phone, which is computed through a GPS and a network, and an MAC address of a nearby Wi-Fi or Bluetooth device and a signal strength, which are searched in an ambient radio environment and transmits the same to the guardian or the emergency rescue organization.

4. The USB memory device of claim 2, wherein the smart phone detects location information of the smart phone, which is computed through a GPS and a network, an MAC address of a Wi-Fi or Bluetooth module of the smart phone, an address of a Bluetooth module of the USB memory device, and a signal strength and transmits the same to the guardian or the emergency rescue organization, and the Wi-Fi module of the smart phone enters into AP mode (Wi-Fi hotspot mode) so that the location of the smart phone may be identified.

5. A USB memory device interworking with a smart phone, the USB memory device comprising:
a USB Bluetooth module for near-field communication with a smart phone Bluetooth module of a smart phone;
a USB connector for connection with an external terminal;
a memory bi-laterally communicating various data with the external terminal through the USB connector and storing the various data transmitted from the external terminal;
a battery supplying power to the USB Bluetooth module; and
a switching device switching on/off power supplied from the USB connector to the memory, wherein when no radio signal for interworking is received from the smart phone, the USB Bluetooth module turns off the switching device to prevent the external terminal from recognizing the memory.

6. The USB memory device of claim 5, wherein when no radio signal for interworking is received from the smart phone, the USB Bluetooth module turns off the switching device to prevent power from being supplied to the memory.

7. The USB memory device of claim 5, further comprising a switching device switching on/off various data bi-laterally communicated through the USB connector between the memory and the external terminal, wherein when no radio signal for interworking is received from the smart phone, the USB Bluetooth module turns off the switching device to prevent the various data from being transmitted from the memory to the external terminal.

8. The USB memory device of claim 5, wherein when no radio signal for interworking is received from the smart phone, the USB Bluetooth module transmits an operation stop signal to the memory to stop the memory from operating.

9. The USB memory device of claim 5, further comprising:
an OTP (One Time Password) generator for generating a password used for an electronic financial transaction;
a displaying device for outputting the password generated by the OTP generator on the screen;
an auxiliary battery for supplying power to the OTP generator; and
a switching device for switching on/off the power supplied from the auxiliary battery through the OTP generator to the displaying device, wherein when no radio signal for interworking is received from the smart phone, the USB Bluetooth module turns off the switching device to prevent power from being supplied to the displaying device.

10. The USB memory device of claim 9, further comprising a switching device switching on/off transmission of the password generated from the OTP generator to the displaying device, wherein when no radio signal for interworking is received from the smart phone, the USB Bluetooth module turns off the switching device to prevent the password from being transmitted to the displaying device.

11. The USB memory device of claim 9, wherein when no radio signal for interworking is received from the smart phone, the USB Bluetooth module transmits a password generation stop signal to the OTP generator so that no password is generated from the OTP generator.

12. The USB memory device of claim 5, wherein only when a separate password is entered, the smart phone outputs a radio signal for interworking.

13. The USB memory device of claim 1, wherein when the USB connector is connected with the external terminal, the battery is charged with power supplied from the external terminal.

14. A USB memory device interworking with a smart phone, the USB memory device comprising:
a USB Bluetooth module for near-field communication with a smart phone Bluetooth module of a smart phone;
a USB connector for connection with an external terminal;
a memory storing various data transmitted from the external terminal through the USB connector;
a battery supplying power to the USB Bluetooth module; and
an interworking button for executing a specific application of the smart phone, wherein when the interworking button is manipulated, the USB Bluetooth module transmits an interworking button radio signal, and when receiving the interworking button radio signal from the USB Bluetooth module, the smart phone executes a pre-registered application.

15. The USB memory device of claim 2, wherein when the USB connector is connected with the external terminal, the battery is charged with power supplied from the external terminal.

16. The USB memory device of claim 5, wherein when the USB connector is connected with the external terminal, the battery is charged with power supplied from the external terminal.
